(19) United States
(12) Patent Application Publication
(10) Pub. No.: US 2009/0262309 A1
(43) Pub. Date: Oct. 22, 2009

(54) PROJECTION TYPE VIDEO DISPLAY APPARATUS

(75) Inventor: Kenji Yamauchi, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/145,632

(22) Filed: Jun. 25, 2008

(30) Foreign Application Priority Data
Jun. 27, 2007 (JP) 2007-168540
Nov. 5, 2007 (JP) 2007-287082

(51) Int. Cl. G03B 21/28

(52) U.S. Cl. 353/37

(57) ABSTRACT

A projection type video display apparatus has a lighting system, which comprises a multiplicity of light sources (11, 12) for emitting substantially parallel beams of light, a half-mirror (13), and a total-reflection mirror (14). The half mirror and the total-reflection mirror are arranged to transmit and/or reflect these beams to illuminate substantially the same entire region of an integrator lens (14). As a result, a high-quality image having no unbalanced white or black dolor uniformity can be obtained even when the light sources are used only partially. This arrangement can be obtained using an inexpensive half-mirror and total-reflection mirror. Moreover, there is no need of precisely positioning the mirrors in alignment with a large number of convex lenses constituting the integrator lens. Thus, the projector can be manufactured at low cost.

### FIELD OF THE INVENTION

This invention relates to a projection type video display apparatus, which utilizes a lighting system having multiple light sources.

### BACKGROUND OF THE INVENTION

There has been known an apparatus in the form of a liquid crystal projector utilizing a lighting system for illuminating liquid crystal panels and projecting images formed on the liquid crystal panels onto a screen in an enlarged scale.

In this type of image display apparatuses, the brighter the projected image is, the higher is the added value of the apparatus. Therefore, a technology has been developed to increase the optical output power of a lighting system, using, for example, multiple-light sources, as disclosed in Japanese Patent Nos. 3408202 and 3594543.

A lighting system of JP-3408202 patent has a lighting system having multiple light sources emitting light to uniformly illuminate the entire region of an integrator lens via optical-path alteration elements. Thus, the optical output power of the lighting system is enhanced and the arc length of the respective light sources is shortened, which can improve the condensation efficiency of the lighting system and extend the life of the light sources. Moreover, such lighting system allows continuous use and uninterrupted projection of the projector if one of the lamps has burnt out.

In the multiple-light system of JP-3408202 patent, however, each light source is designed to illuminate only a portion (e.g. a half or a smaller sectional region) of the integrator lens that unbalanced white color uniformity or unbalanced black color uniformity are likely to appear in the image formed if the multiple light sources are turned on only partially. Besides, in this prior art projector accurate positioning of the lighting system in alignment with a large number of convex lenses constituting the integrator lens is necessary, which renders the lighting system, and hence the projector, costly.

The JP-3594543 patent particularly has a lighting system which includes two sets of 2-light sources (4 light sources in total), with the two sets vertically offset to each other such that one light source illuminates one of four quadrants (upper and lower sections of right and left halves) of an integrator lens. Should one of the four light sources burn out, the other one arranged at an upper or a lower diagonal position and having supposedly counterbalancing hue characteristics with the burnt light source, is turned off to cancel out unbalanced color uniformity, in sacrifice of the brightness of the picture. In addition to a 4-light mode in which all of the four light sources are turned on, the lighting system can be switched over to a 2-light energy saving mode in which only two counterbalancing diagonal light sources can be turned on under reduced brightness while suppressing unbalanced color uniformity.

In this lighting system of the JP-3594543 patent, each of the light sources illuminates only a particular one-fourth region of the integrator lens; the light valves of the liquid crystal panels have characteristic of viewing angle; and the light sources for illuminating the liquid crystal panels have different irradiation angles, as described in the cited patent document. On account of further incidence-angle dependence of dichroic mirrors for splitting white light into RGB components, not only unbalanced white color uniformity and unbalanced black color uniformity but also white and black hue difference is likely to appear in the 2-light modes. In actuality, therefore, only three modes can be used: a 4-light mode (full illumination mode) and two 2-light modes in which two diagonal light sources having counterbalancing coloring characteristics are turned on.

### SUMMARY OF THE INVENTION

In view of such prior art problems, the present invention seeks to provide a projection type video display apparatus at low manufacturing cost, which is yet capable of providing an image of a favorable picture quality without any unbalanced white color uniformity or unbalanced black color uniformity if the light sources of the lighting system are turned on only partially.

An inventive projection type video display apparatus can be implemented with four light sources that can be used in various 2-light modes, which exhibits less unbalanced white/black color uniformity and less white and black hue difference in the 2-light modes.

To this end, there is provided in accordance with one aspect of the invention a projection type video display apparatus for projecting beams of imaging light obtained by modulating the light emitted from a lighting system and illuminating optical elements via an integrator lens, the lighting system comprising:

a multiplicity of light sources for emitting substantially parallel beams of light; and

at least one half-mirror and at least one total-reflection mirror for transmitting and/or reflecting the beams emitted from the light sources to illuminate substantially the same entire region of the integrator lens.

In this arrangement, the beams of light emitted from each light source can illuminate substantially the same entire integrator lens, so that a favorable image having no unbalanced white or black color uniformity can be obtained even when the light sources are partially used. This arrangement can be obtained using an inexpensive half-mirror and total-reflection mirror, and, moreover, there is no need of accurate positioning or alignment of the mirrors in alignment with a large number of convex lenses constituting the integrator lens. Hence, the projector can be manufactured at low cost.

In the case where the projector is used as a typical 2-light projector, the lighting system may have

a first light source;

a second light source having an optical axis perpendicular to the optical axis of the first light source;

a half mirror arranged at a position where the optical axes of the first and second light sources cross each other, and inclined with respect to the respective optical axes at 45 degrees;

a total-reflection mirror arranged at a predetermined position on the optical axis of the first light source and downstream of the half mirror, and inclined with respect to the optical axis of the first light source at 45 degrees, wherein

the half mirror and total-reflection mirror are arranged such that the beams of light transmitted and/or reflected therefrom to the integrator lens are substantially parallel to each other, propagate in close proximity to each other, and fall on the integrator lens at substantially right angles.

When the projector is used as a further typical 2-light projector, the lighting system may have

a first light source;

a second light source having an optical axis parallel to the optical axis of the first light source;

a first total-reflection mirror for reflecting the incident beams of light emitted from the second light source in the direction perpendicular to the incident beam;

a half mirror arranged at a position where the beams of light reflected from the total-reflection mirror crosses the optical axis of the first light source, with the normal of the half mirror being inclined with respect to the optical axis of the first light source and to the beams of light reflected from the total-reflection mirror at 45 degrees; and

a second total-reflection mirror arranged at a predetermined position on the optical axis of the first light source and downstream of the half mirror, and inclined with respect to the optical axis of the first light source at 45 degrees, wherein

the half mirror and the second total-reflection mirror are respectively arranged such that beams of light transmitted and/or reflected therefrom to the integrator lens are substantially parallel to each other, propagate in close proximity, and fall on the integrator lens at substantially right angles.

The optical elements of the projector may be arranged such that the optical axes of the respective light sources are perpendicular to the direction of the beams of imaging light projected.

Alternatively, the lighting system may be configured to include:

vertically offset upper and lower pairs of light sources for emitting substantially parallel beams of light; and

half mirrors and total-reflection mirrors for transmitting and/or reflecting the substantially parallel beams of light emitted from the light sources such that the light sources belonging to the upper pair illuminate substantially the same upper half region of the integrator lens while the light sources belonging to the lower pair illuminate substantially the same lower half region of the integrator lens.

Such a 4-light lighting system as described above may comprise:

a first light source;

a second light source having an optical axis perpendicular to the optical axis of the first light source;

a first half mirror arranged at a position where the optical axes of the first and second light sources cross each other, and inclined with respect to the respective optical axes at 45 degrees;

a first total-reflection mirror arranged at a predetermined position on the optical axis of the first light source and downstream of the first half mirror, and inclined with respect to the optical axis of the first light source at 45 degrees;

a third light source vertically offset with respect to the first light source;

a fourth light source having an optical axis perpendicular to the optical axis of the third light source;

a second half mirror arrange at a position where the optical axes of the third and fourth light sources cross each other, and inclined with respect to the respective optical axes of the third and fourth light sources at 45 degrees; and

a second total-reflection mirror arranged at a predetermined position on the optical axis of the third light source and downstream of the second half mirror, and inclined with respect to the optical axis of the third light source at 45 degrees, wherein

the half mirrors and total-reflection mirrors are arranged such that the beams of light transmitted and/or reflected therefrom to the integrator lens are substantially parallel to each other, propagate in close proximity to each other, and fall on the integrator lens at substantially right angles.

In a further 4-light projector, the lighting system may include:

a first light source;

a second light source having an optical axis parallel to the optical axis of the first light source;

a first total-reflection mirror for reflecting the incident beams of light emitted from the second light source in the direction perpendicular to the incident beam;

a first half mirror arranged at a position where the beams of light reflected from the first total-reflection mirror crosses the optical axis of the first light source, and inclined with respect to the optical axis of the first light source and to the beams reflected from the first total-reflection mirror at 45 degrees; and a second total-reflection mirror arranged at a predetermined position on the optical axis of the first light source and downstream of the first half mirror, and inclined with respect to the optical axis of the first light source at 45 degrees;

a third light source vertically offset with respect to the first light source;

a fourth light source having an optical axis parallel to the optical axis of the third light source;

a third total-reflection mirror for reflecting the incident beams of light emitted from the fourth light source in the direction perpendicular to the incident beam;

a second half mirror arranged at a position where the beams of light reflected from the third total-reflection mirror crosses the optical axis of the third light source, and inclined with respect to the optical axis of the third light source and to the beams reflected from the third total-reflection mirror at 45 degrees; and

a fourth total-reflection mirror arranged at a predetermined position on the optical axis of the third light source and downstream of the second half mirror, and inclined with respect to the optical axis of the third light source at 45 degrees, wherein

the first and second half mirrors and the second and fourth total-reflection mirrors are arranged such that the beams of light transmitted and/or reflected therefrom to the integrator lens are substantially parallel to each other, propagate in close proximity to each other, and fall on the integrator lens at substantially right angles.

In this arrangement, the optical elements of the projector may be arranged such that the optical axes of the respective light sources are perpendicular to the direction of the beams of imaging light projected.

### BRIEF DESCRIPTION OF THE DRAWINGS

FIG. 1 is a diagram showing an arrangement of a lighting system in accordance with one embodiment of the invention.

FIG. 2 is a diagram showing an arrangement of a liquid crystal projector using the lighting system of FIG. 1.

FIG. 3 is a diagram showing an arrangement of a lighting system in accordance with another embodiment of the invention.

FIG. 4 is a diagram showing an arrangement of a liquid crystal projector using the lighting system of FIG. 3.

FIG. 5 is a diagram showing an arrangement of a lighting system in accordance with a further embodiment of the invention.

FIG. 6 is a diagram showing an arrangement of light sources (first and second light sources) disposed at a lower level in the lighting system shown in FIG. 5.

FIG. 7 is a diagram showing an arrangement of light sources (third and fourth light sources) disposed at an upper level in the lighting system shown in FIG. 5.

FIG. 8 is a diagram showing an arrangement of a liquid crystal projector using the lighting system shown in FIG. 5.

FIG. 9 is a diagram showing an arrangement of a lighting system in accordance with a further embodiment of the invention.

### DETAILED DESCRIPTION OF THE PREFERRED EMBODIMENTS

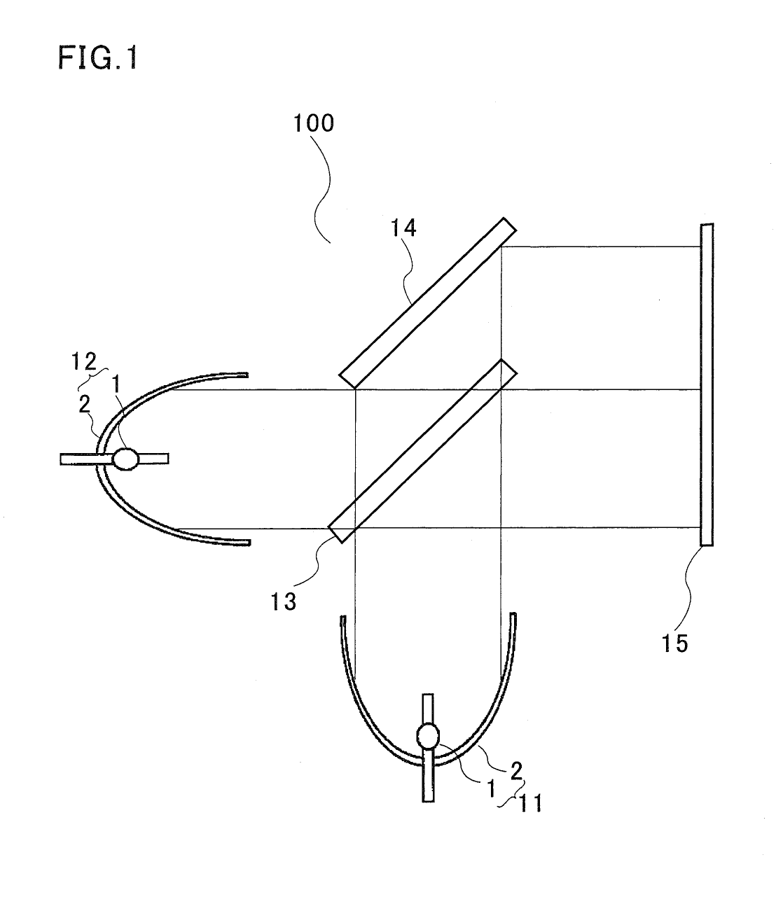

Referring to FIG. 1, there is shown an arrangement of a lighting system 100 in accordance with one embodiment of the invention.

As shown in FIG. 1, the lighting system 100 is a 2-light lighting system, which has a first light source 11 and a second light source 12. Each of the light sources 11 and 12 includes a luminescent section 1 comprising, for example, an ultrahigh pressure mercury lamp and a paraboloidal mirror 2 for reflecting the light emitted from the luminescent section 1 in a substantially parallel beam.

Each of the first and second light sources 11 and 12, respectively, emits light along the axis of the paraboloidal mirror (the axis hereinafter referred to as optical axis of the light source). The two light sources are arranged with their optical axes oriented perpendicular to each other. Located at a position where the optical axes of the light sources 11 and 12 cross each other is a half mirror 13, which is inclined with respect to the optical axes of these light sources at 45 degrees. In addition, located at a predetermined position on the optical axis of the first light source 11 and downstream of the half mirror 13 is a total-reflection mirror 14 inclines to the optical axis of the first light source 11 at 45 degrees.

The half mirror 13 and the total-reflection mirror 14 are arranged such that the beams of light emitted from the two light sources are transmitted and/or reflected to an integrator lens 15 in substantially parallel to each other, propagate in close proximity, and fall on the integrator lens 15 at substantially right angles.

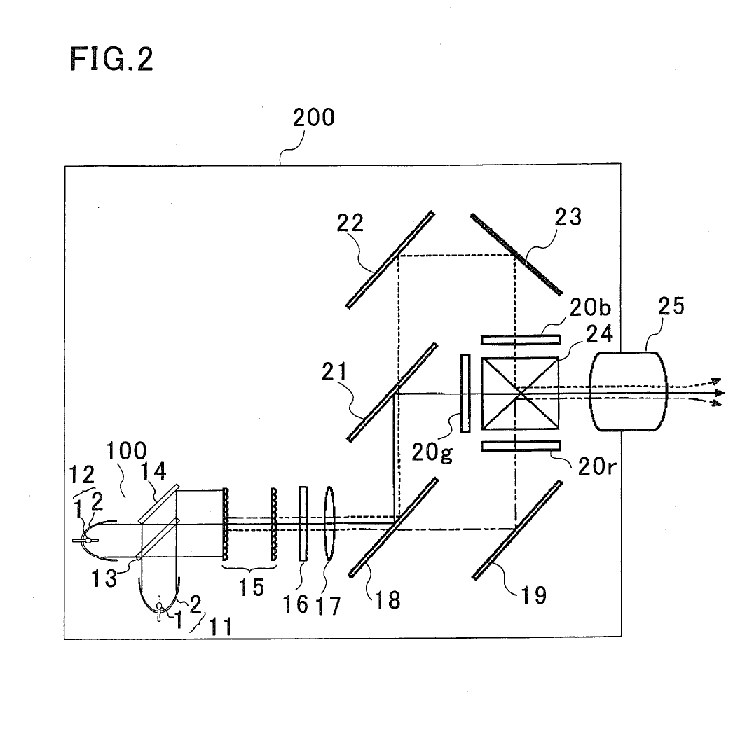

FIG. 2 shows an arrangement of an optical system of a liquid crystal projector 200, which is obtained by providing a liquid crystal projector of JP-3408202 patent with the lighting system 100 shown in FIG. 1.

White light emitted from the lighting system 100 illuminates the integrator lens 15. The light that has passed through the integrator lens 15 is led to a polarization converter 16. The integrator lens 15 consists of two groups of lenses, each group having a large number of convex lenses designed to uniformize the density of a rather non-uniform light flux passing through them, so that the entire surface of a liquid crystal panel will be illuminated uniformly, as described later, without being influenced by an inherent non-uniformity in luminosity of the lighting system 100.

The polarization converter 16 includes a polarization separation film and a retardation film (½-wavelength plate). The light coming from the integrator lens 15 and entering the polarization converter 16 is separated into P and S polarization components by the polarization separation film. While one of the two components is transmitted from the polarization converter 16 as it is, the polarization state of the other component is converted by the retardation film so that the light is entirely transmitted from the polarization converter 16 in P polarized or S polarized state.

After passing through the polarization converter 16, the linearly polarized light passes through a condenser lens 17, and is led to a first dichroic mirror 18. The first dichroic mirror 18 transmits light in the red wavelength zone, but reflects light in the cyanogen zone (green and blue zones). The light in the red wavelength zone that has passed through the first dichroic mirror 18 is reflected by a total-reflection mirror 19 to a transmission-type liquid crystal panel 20r, where the light is modulated, as it passes through it, by a picture signal.

On the other hand, the light in the cyanogen wavelength zone reflected by the first dichroic mirror 18 is led to a second dichroic mirror 21. The second dichroic mirror 21 transmits the light in the blue wavelength zone, but reflects the light in the green wavelength zone. The light in the green wavelength zone, reflected by the second dichroic mirror 21, is led to a transmission-type liquid crystal panel 20g for green light. The light passing through the liquid crystal panel 20g is then modulated by another picture signal.

After passing through the second dichroic mirror 21, the light in the blue wavelength zone is led to a transmission-type liquid crystal panel 20b for blue light via total-reflection mirrors 22 and 23. The light passing through the liquid crystal panel 20b is then modulated by still another picture signal.

The beams of modulated (red, green, and blue) light that have passed through the liquid crystal panels 20r, 20g, and 20b are synthesized by a dichroic prism 24 into beams of colored imaging light. This colored imaging light is projected by a projection lens 25 onto a screen.

In this arrangement, a half of the substantially parallel beams of light emitted from the first light source 11 is reflected by the half mirror 13 onto about one half region (lower half region) of the integrator lens 15, while the rest of the beams passing through the half mirror 13 reach the total-reflection mirror 14, where the beams are totally reflected to the remaining one half region (upper half region) of the integrator lens 15 as shown in FIGS. 1 and 2. Thus, it is possible to illuminate the entire region of the integrator lens 15 with the first light source 11.

Similarly, like the light emitted from the light source 11, one half of substantially parallel beams of light emitted from the second light source 12 is transmitted by the half mirror 13 onto about one half region (lower half region) of the integrator lens 15, and the rest of the beams are reflected to the total-reflection mirror 14, where the beams are reflected to the remaining half region (upper half region) of the integrator lens 15, as shown in FIGS. 1 and 2. Thus, the second light source 12 can also illuminate substantially the entire surface of integrator lens 15.

As a consequence, both the first and second light sources 11 and 12, respectively, can illuminate substantially the same entire region of the integrator lens 15. As a result, should one of the light sources 11 and 12 burn out at the end of its life, or if one of them is temporally turned off to save energy, still a picture of good quality can be obtained, free of unbalanced white or black color uniformity. It should be appreciated that this optical system can be built using an inexpensive half mirror and total-reflection mirror, and requires no accurate positioning of the mirrors in alignment with a large number of convex lenses of the integrator lens 15, thereby facilitating reduction of the manufacturing cost of the projector.

Incidentally, there are some occasions where a projection-type liquid crystal projector as described above is used to project an image onto a lifted screen, or in an extreme case onto a ceiling, which requires the projection lens (or the projector itself) to be upwardly inclined (at some other time, downwardly inclined).

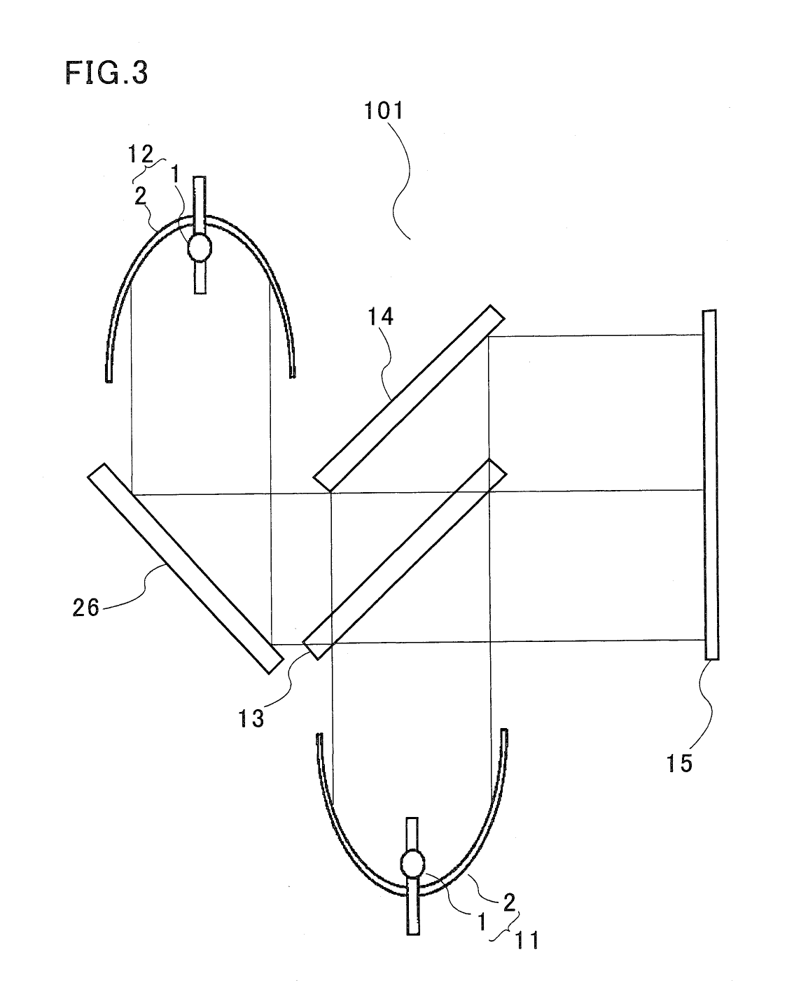

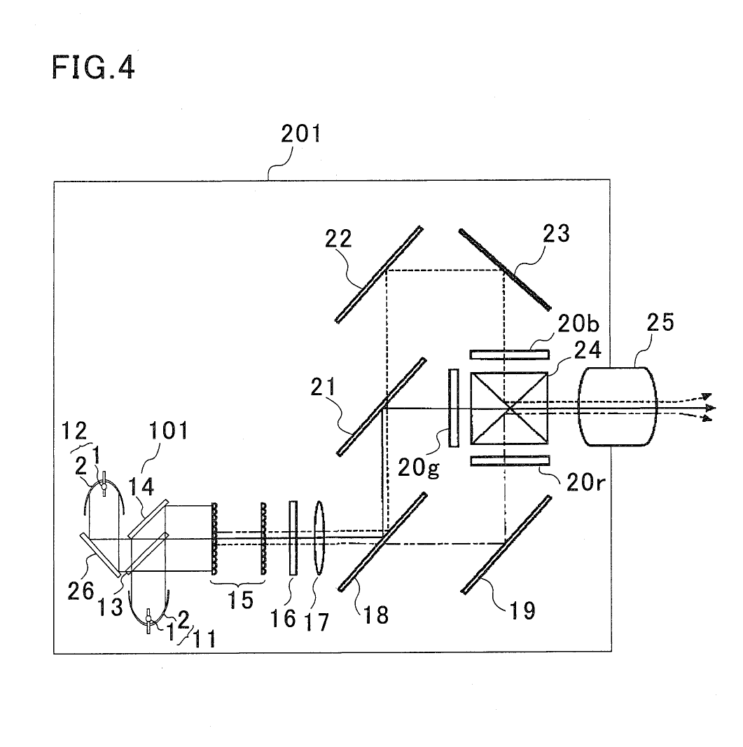

Usually, an ultrahigh-pressure mercury lamp having an arc length of about 1-1.5 mm or so is used as a light source of a projection type video display apparatus. If, however, the projection lens 25 of a liquid crystal projector 200 as shown in FIG. 2 is inclined upward at an ascending angle of 15 degrees or more, then the optical axis of the second light source 12 is also inclined upward. Then, due to a characteristic of the light source of this type, the lamp seal section (near the electrodes) of the second light source 12 becomes heated to a high temperature, causing deterioration and early fracture of the light source 12. Referring to FIGS. 3 and 4, there is shown an embodiment designed to circumvent this drawback.

FIG. 3 shows an arrangement of a lighting system 101 in accordance with a second embodiment of the invention. Like reference numerals in FIGS. 1 and 3 indicate like or corresponding elements.

A lighting system 101 is also a 2-light lighting system, which includes a first light source 11 and a second light source 12. Each of the light sources 11 and 12 includes a luminescent section 1 having, for example, an ultrahigh pressure mercury lamp, and a paraboloidal mirror 2 for reflecting the light emitted from the luminescent section 1 in a substantially parallel beam.

The first and second light sources 11 and 12, respectively, are arranged with their optical axes oriented in parallel to each other in opposite directions so that the two axes do not coincide with each other. Moreover, a total-reflection mirror 26 is provided on the optical axis of the second light source 12, and inclined with respect to the optical axis at 45 degrees. As in the foregoing embodiment, a half mirror 13 is arranged at a position where the optical axis of the first light source 11 crosses the beams of light emitted from the second light source and reflected by the total-reflection mirror 26, and inclined with respect to the optical axis of the first light source 11 and to the reflected beams at 45 degrees. In addition, a total-reflection mirror 14 is located at a position on the optical axis of the first light source 11 and downstream of the half mirror 13, and inclined with respect to the optical axis of the first light source 11 at 45 degrees.

The half mirror 13 and the total-reflection mirror 14 are arranged, as in the first embodiment, such that the beams of light transmitted and/or reflected therefrom to the integrator lens 15 are substantially parallel to each other, propagate in close proximity to each other, and fall on the integrator lens 15 at a substantially right angle.

It should be understood that although the first and second light sources 11 and 12, respectively, are shown in FIG. 3 to have their optical axes oriented in parallel to each other in opposite directions so as not to coincide with each other, the first and second light source 11 and 12, respectively, may be arranged to have their optical axes oriented in parallel in the same direction by rotating the mirror 26 in the clockwise direction by 90 degrees at the same position shown in FIG. 3 to avoid coincidence of these optical axes. Alternatively, the first and second light sources 11 and 12, respectively, may be arranged to have their optical axes coincide with each other but oriented in opposite directions (that is, the second light source 12 is arranged on the optical axis of the first light source 11 with its optical axis oriented in parallel to, but in the opposite direction to, the optical axis of the first light source). In this case, two additional total-reflection mirrors are provided to deflect, through multiple orthogonal total-reflections, the beams emitted from the second light source to the total-reflection mirror 26 of FIG. 3.

Referring to FIG. 4, there is shown an arrangement of a projection-type liquid crystal projector 201 obtained by providing the liquid crystal projector of JP-3408202 patent with a lighting system 101 shown in FIG. 3. In FIGS. 3 and 4, like reference numerals indicate like or corresponding elements. Except for the lighting system 101, the elements shown in FIG. 4 are the same as shown in FIG. 2. Hence, description of these elements will be omitted below.

In this arrangement, as in the preceding embodiment, a half of the substantially parallel beams of light emitted from the first light source 11 is reflected by the half mirror 13 onto about one half region (lower half region in FIGS. 3 and 4) of the integrator lens 15 and the rest of the beams is transmitted to the total-reflection mirror 14, which beams are then reflected by the total-reflection mirror 14 onto the remaining half region (upper half region in FIGS. 3 and 4) of the integrator lens 15. Thus, the first light source 11 can illuminate substantially the entire surface of the integrator lens 15.

Substantially parallel beams of light emitted from the second light source 12 is totally reflected by the total-reflection mirror 26 to the half mirror 13. One half of the beams is transmitted by the half mirror 13 onto about one half region (lower half region in FIGS. 3 and 4) of the integrator lens 15, like the beams of the first light source 11 reflected by the half mirror 13. The rest of the beams is reflected by the half mirror 13 to the total-reflection mirror 14, and totally reflected by the total-reflection mirror 14 onto the remaining region (upper half region in FIGS. 3 and 4) of the integrator lens 15, like the beams of the first light source 11 reflected by the total-reflection mirror 14. Thus, the second light source 12 can also illuminate substantially the entire surface of the integrator lens 15.

Therefore, both of the first and second light sources 11 and 12, respectively, can illuminate substantially the same entire surface of the integrator lens 15. Thus, should one of the light sources 11 and 12 has burn out at the end of its life, or if one of them is temporally turned off to save energy, a picture of good quality, free of unbalanced white or black uniformity, can be obtained. It should be appreciated that this lighting system can be built using an inexpensive half mirror and total-reflection mirror and requires no accurate positioning of the mirrors in alignment with a large number of convex lenses of the integrator lens 15, which facilitates reduction of the manufacturing cost of the projector. A further arrangement of the lighting system not to shorten the lives of the light sources can be provided as follows.

To do so, the optical axes of the light sources 11 and 12 of the lighting system 101 installed in the liquid crystal projector 201 as shown in FIG. 3 are oriented perpendicular to the beams of imaging light projected from the projection lens 25, as shown in FIG. 4. In this arrangement, even if the liquid crystal projector 201 is set up with the optical axis of projection lens 25 is upwardly inclined at about 15 degrees or more, none of the optical axes of the light sources 11 and 12 is inclined at all, so that their lamp seal sections will not be heated beyond the rated temperature.

Although two 2-light lighting systems have been described above as the most frequently used examples of multi-light lighting systems, the number of light sources can be further increased by utilizing in combination a multiplicity of 2-light units each being in the form of, for example, the light source 100 or 101 and serving just like one light source 11 or 12.

It would be understood that the optical system of the invention is not limited to the one as shown in FIGS. 2 and 4. Rather, the invention can be used with different types of optical systems.

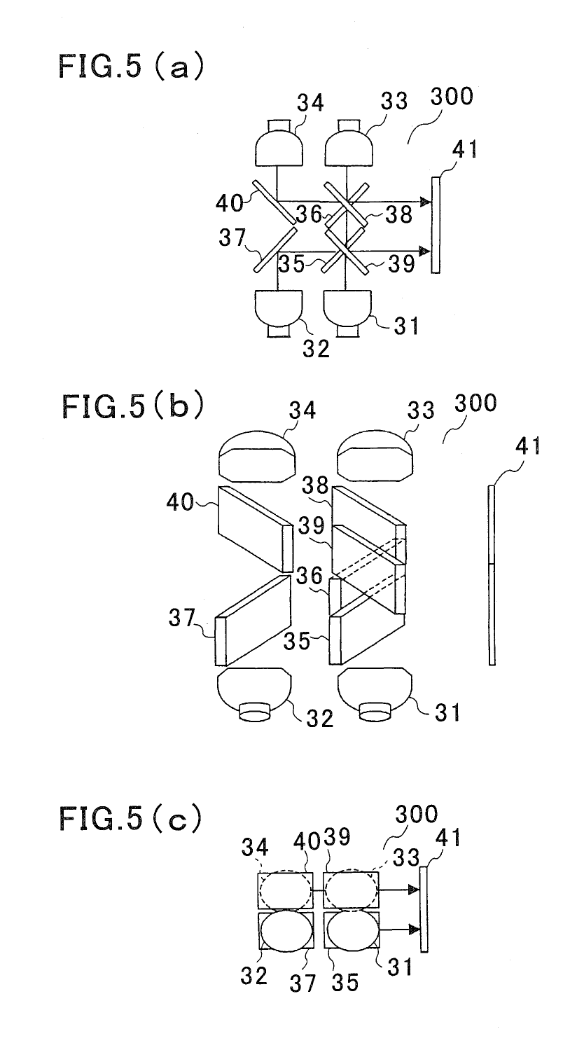

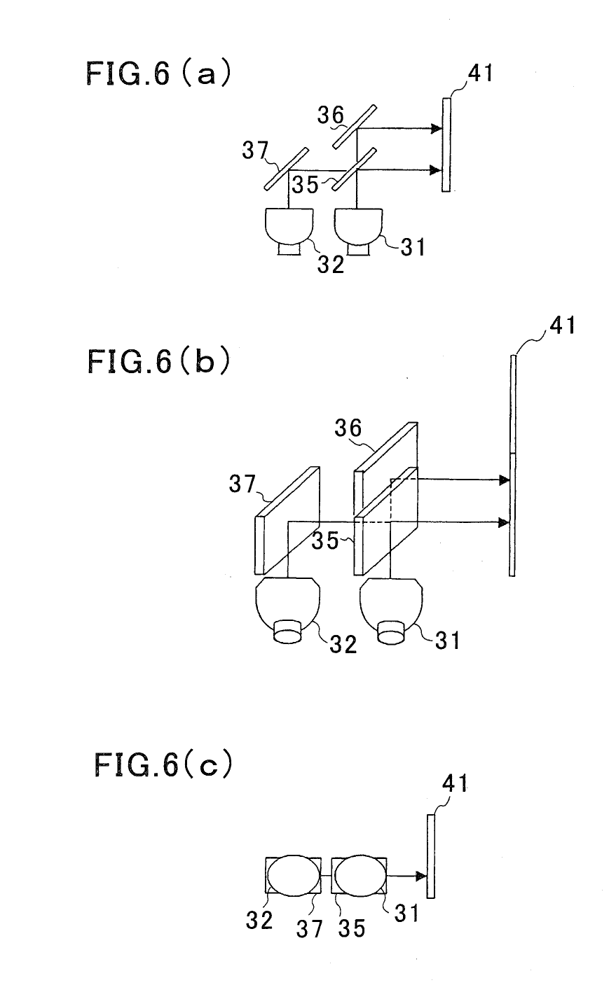

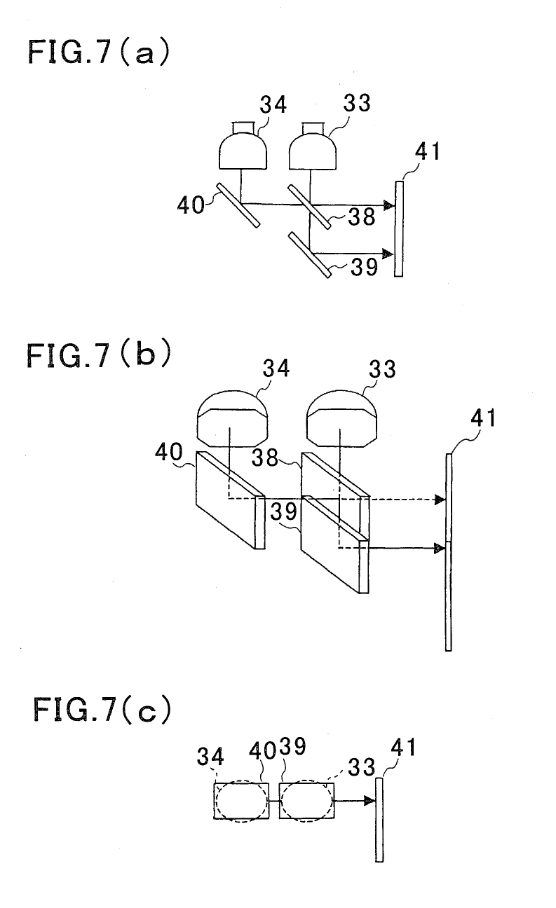

FIG. 5 shows a plan (a), perspective (b), and side elevation (c) of a lighting system 300 in accordance with a further embodiment of the invention. FIG. 6 shows a plan (a), perspective (b), and side elevation (c) of a lower section (including the first and second light sources) of lighting system of FIG. 5. FIG. 7 shows a plan (a), perspective (b), and side elevation (c) of an upper section (including the third and fourth light sources) of the lighting system of FIG. 5.

As shown in FIG. 5, the lighting system 300 is a 4-light lighting system, which has a first, second, third, and fourth light source 31, 32, 33, and 34, respectively. Each of the light sources 31-34 comprises a lamp such as a ultrahigh pressure mercury lamp, a metal halide lamp, or a xenon lamp, and a reflector for outputting substantially parallel beams of illumination light emitted from the lamp.

The first and second light sources 31 and 32 at the lower level, respectively, are arranged with their optical axes oriented in parallel to each other in the same direction to avoid coincidence with each other, as shown in FIGS. 5 and 6. As in the first embodiment, a half mirror 35 and a total-reflection mirror 36 are arranged at predetermined positions on the optical axis of the first light source 31 and inclined with respect to the optical axis of the first light source 31 at 45 degrees. The half mirror 35 and the total-reflection mirror 36 are arranged such that the beams of light transmitted and/or reflected therefrom to the integrator lens 41 are substantially parallel to each other, propagate in close proximity to each other, and fall on the integrator lens 41 at a substantially right angle. Thus, the light emitted from the first light source 31 can illuminate substantially the entire lower half region of the integrator lens 41.

In addition, a further total-reflection mirror 37 is arranged on the optical axis of the second light source 32. The total-reflection mirror 37 is inclined with respect to the optical axis of the second light source 32 at 45 degrees such that the beams of light reflected by the total-reflection mirror 37 cross the optical axis of the first light source 31 on the half mirror 35 and coincide with the beams of light emitted from the first light source 31 and reflected from the half mirror 35. Thus, both of the first and second light sources 31 and 32, respectively, can illuminate substantially the same lower half region of the integrator lens 41.

On the other hand, the third and fourth light sources 33 and 34, respectively, are offset upward from the first and second light sources 31 and 32, respectively, and arranged with their optical axes oriented in parallel to each other in the opposite direction with respect to the optical axes of the first and second light sources 31 and 32, respectively, to avoid coincidence of the optical axes, as shown in FIGS. 5 and 7. Similarly, a half mirror 38 and a total-reflection mirror 39 are arranged at predetermined positions on the optical axis of the third light source 33 in the order mentioned, and inclined with respect to the optical axis of the third optical source 33 at 45 degrees. Like the half mirror 35 and the total-reflection mirror 36 at the lower level, the half mirror 38 and the total-reflection mirror 39 are arranged such that the beams of light transmitted and/or reflected therefrom to the integrator lens 41 are substantially parallel to each other, propagate in close proximity to each other, and fall on the integrator lens 15 at substantially right angles. That is, as shown in FIG. 5, the half mirror 38 is arranged above the lower total-reflection mirror 36 with their mirror planes being perpendicular to each other, and the total-reflection mirror 39 is arranged above the lower half mirror 35 with their mirror planes being perpendicular to each other. Thus, the third light source 33 can illuminate the substantially entire upper half region of the integrator lens 41.

In addition, a total-reflection mirror 40 is arranged on the optical axis of the fourth light source 34. The total-reflection mirror 40 is inclined with respect to the optical axis of the fourth light source 34 at 45 degrees such that the beams of light reflected from the total-reflection mirror 40 cross the optical axis of the third light source 33 on the half mirror 38 and coincide with the beams of light emitted from the third light source 33 and reflected by the half mirror 38. Thus, both of the third and fourth light sources 33 and 34, respectively, can illuminate substantially the same upper half region of the integrator lens 41.

The first and second light sources 31 and 22, respectively, are shown in FIG. 5 to have their optical axes in parallel to each other in the same direction to avoid coincidence of these optical axes, and so are the third and fourth light sources 33 and 34, respectively. However, the total-reflection mirror 37 on the optical axis of the second light source 32 may be rotated in the counterclockwise direction by 90 degrees and the total-reflection mirror 40 on the optical axis of the fourth light source 34 may be rotated in the clockwise direction by 90 degrees, and the fourth light source 34 is shifted to the lower level to serve as the second light source while at the same time the light source 32 is shifted to the upper level to serve as the fourth light source to thereby orienting the optical axes of the first and second light sources, and the optical axes of the third and fourth light sources as well, in parallel to each other in opposite directions without coinciding with each other. Alternatively, the first and second light sources 31 and 32, respectively can be re-arranged to face each other so as to have their optical axes oriented in parallel to each other, but in opposite directions, and so are the third and fourth light sources 33 and 34, respectively (that is, the second light source 32 of FIG. 5 can be re-arranged on the optical axis of the first light source 31 and below the third light source 33, and the fourth light source 34 re-arranged on the optical axis of the third light source 33 and above the first light source 31), wherein the beams of light emitted from the second light source 32 and the fourth light source 34 are respectively re-directed, through multiple orthogonal total-reflections, to the total-reflection mirror 37 and to the total-reflection mirror 40 by means of a few extra total-reflection mirrors. Further alternative arrangements of the light sources are possible by adding and/or rotating total-reflection mirrors in a similar fashion.

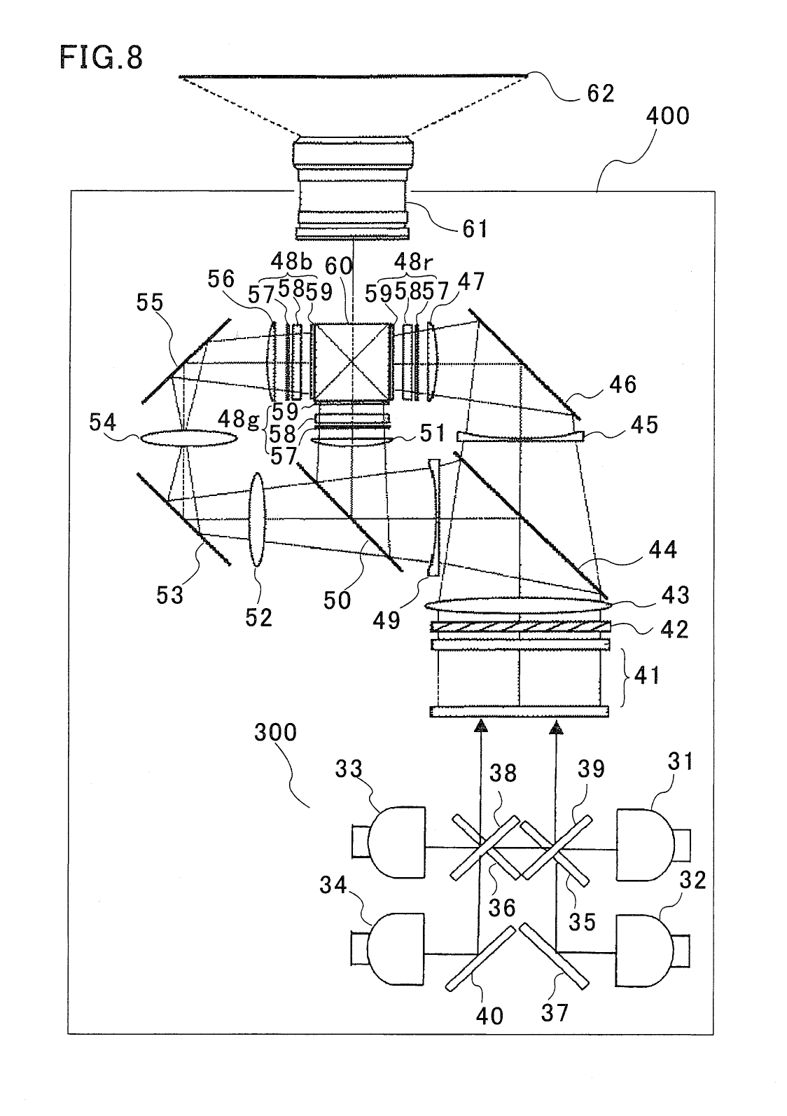

Referring to FIG. 8, there is shown an arrangement of an optical system of a liquid crystal projector 400, which is obtained by providing a 4-light, 3-panel type liquid crystal projector of JP-3594543 patent with the lighting system 300 shown in FIG. 5.

In this arrangement, white light emitted from the lighting system 300 is led to the integrator lens 41 in the manner as described above. The integrator lens 41 consists of two groups of a number of convex lenses each designed to lead the light emitted from the lighting sources 31-34 uniformly to the entire regions of liquid crystal light valves as described below. After passing through the integrator lens 41, the light is lead to a first dichroic mirror 44 via a polarization converter 42 and a condenser 43.

The polarization converter 42 consists of an array of a multiplicity of polarization beam splitters (hereinafter referred to as PBS array) and a multiplicity of retardation films (½ wavelength plates). Each of the beam splitters includes a polarization separation film (not shown) for splitting light coming from the integrator lens 15 into P- and S-polarized light and a reflective film (not shown). The polarization separation film transmits P-polarized component, for example, as it is, and deflects the S-polarized component by 90 degrees, which is again deflected by the reflective film by 90 degrees before it is transmitted from the beam splitter. The P-polarized light passing through the PBS array is changed into S-polarized light by a retardation film provided on the light emerging side of the PBS array as it is transmitted therefrom. That is, substantially all the light entering the PBS array is transmitted therefrom in S-polarized state.

The first dichroic mirror 44 transmits light in the red wavelength zone, but reflects light in the cyanogen zone (green and blue zones). The light in the red wavelength zone that has passed through the first dichroic mirror 44 is directed, via a concave lens 45, to a total-reflection mirror 46, which reflects the red light to a lens 47. Passing through the lens 47, the red light is lead to a transmission-type liquid crystal light valve 48r, which modulate the light based on a picture signal. On the other hand, the light in the cyanogen wavelength zone, reflected by the first dichroic mirror 44, is led to a second dichroic mirror 50 via a concave lens 49.

The second dichroic mirror 50 transmits light in the blue wavelength zone, and reflects light in the green wavelength zone. The light in the green wavelength zone, reflected by the second dichroic mirror 50, passes through a lens 51 and led to a transmission-type liquid crystal light valve 48g, which modulate the light based on another picture signal as the light passes through it. After passing through the second dichroic mirror 50, the light in the blue wavelength zone goes through a relay lens 52, total-reflection mirror 53, relay lens 54, total-reflection mirror 55, and lens 56, and reaches a transmission-type liquid crystal light valve 48b, where the light is modulated by a further picture signal as the light passes through it.

Each of the liquid crystal light valves 48r, 48g, and 48b includes: a polarization plate (referred to as incidence side polarization plate) 57 provided on the incidence side of the light valve, a liquid crystal panel 58 which consists of a pair of glass substrates (having thereon pixel electrodes and oriented films) and a liquid crystal enclosed therebetween, and a polarization plate (referred to as emerging side polarization plate) 59 provided on the light emerging side of the light valve. In this embodiment, the incidence side polarization plate 57 absorbs P-polarized light, and transmits S-polarized light.

The colored beams of light modulated in the respective liquid crystal light valves 48r, 48g, and 48b are synthesized by a dichroic prism 60 into beams of colored imaging light. The colored imaging light is projected onto a screen 62 by a projection lens 61.

In this arrangement, both the light emitted from the first and second light sources 31 and 32, respectively, can illuminate substantially the same lower half region of the integrator lens 41, as described above. Similarly, both the light emitted from the third and fourth light sources 33 and 34, respectively, can illuminate substantially the same upper half region of the integrator lens 41. It is noted that, if the first and second light sources 31 and 32, respectively, are arranged at the upper level and the third and fourth light sources 33 and 34, respectively, are arranged at the lower level in the lighting system, the respective light sources illuminate the opposite half regions of the integrator lens 41.

Therefore, even in a 2-light mode, where only one light source in the upper and in the lower level is turned on due to, for example, lamp burn out, the lighting system can illuminate substantially the entire region of the integrator lens 41. Accordingly, unbalanced white color uniformity and unbalanced black color uniformity that could appear in conventional two-light modes are suppressed, and furthermore, an appreciable difference in whiteness and blackness levels in an image is less likely to occur between the two modes.

It should be appreciated that the inventive projector has a superb usability over the conventional projector of JP-3594543 patent in that, in comparison with the conventional projector which is usable in practically only three lighting modes, the inventive projector can be advantageously used in 5 different lighting modes which includes: a 4-light mode (with all light sources turned on) and four 2-light modes (with one light source in the upper level and one light source in the lower level turned on). The four 2-light modes can be obtained by pairing: the first light source 31 and third light source 33; first light source 31 and fourth light source 34; second light source 32 and third light source 33; and second light source 32 and fourth light source 34. Moreover, lives of the light sources can be extended by sequentially switching from one 2-light mode to another with time. It is noted that even in the 2-light lighting system, lives of the light sources can be also extended by alternately turning on only one of the two light sources. Further, the lighting system can be configured not to deteriorate the light sources, as described below.

To do so, the optical elements of the projector are arranged so as to orient the optical axes of the light sources 31 through 34 of the lighting system 300 of FIG. 5 perpendicular to the optical axis of the projection lens 61, as shown in FIG. 8. In this arrangement, as in the embodiment shown in FIG. 4, none of the optical axes of the light sources 31-34 is inclined at all even when the optical axis of the projection lens is upwardly inclined to about 15 degrees or more, thereby preventing their lamp seal sections from being heated beyond the rated temperature.

If the projector will never be upwardly inclined to more than 15 degrees, the lighting system may be configured as described below.

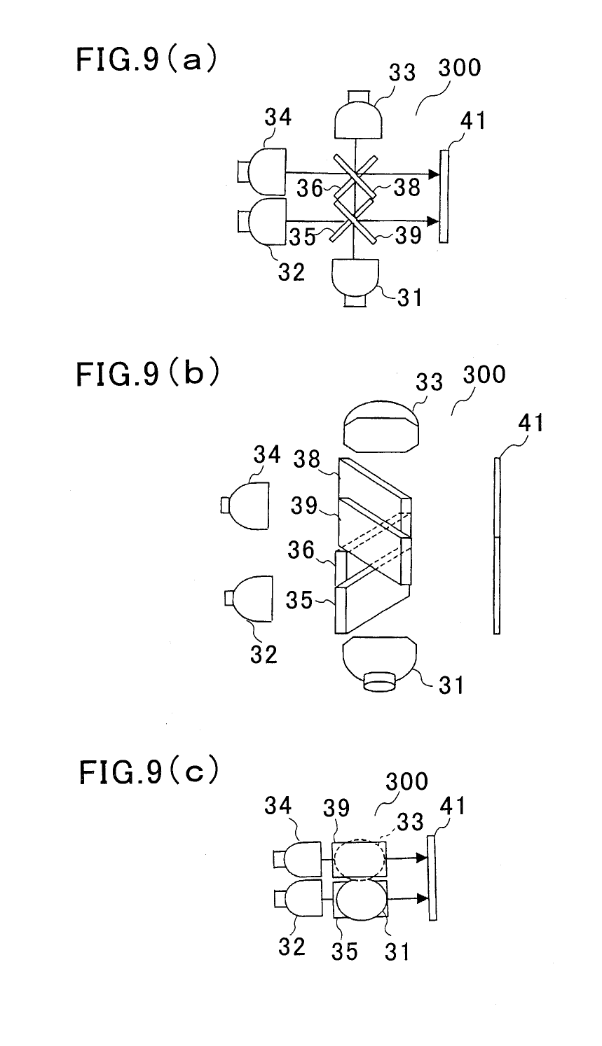

FIG. 9 shows a lighting system in accordance with a still further embodiment of the invention. More particularly, FIG. 9(a), (b), and (c) are respectively a plan, perspective, and side elevation of the lighting system. Like reference numerals in FIGS. 9 and 5 indicate like or corresponding elements, for which further description will not be repeated below.

In this embodiment, the total-reflection mirrors 37 and 40 of FIG. 5 are removed and the second light source 32 and the fourth light source 34, respectively, are re-located to the positions of these mirrors with their optical axes crossing the optical axes of the first and third light sources 31 and 33, respectively, at right angles.

This configuration ensures substantially the same merits as the preceding embodiment shown in FIG. 8 if the projector is fixedly installed in use and not inclined upwardly more than 15 degrees. This projector is structurally simple and can be manufactured at a lower cost.

The optical system for use in the invention is not limited to the one shown in FIG. 8. Rather, the invention can be applied to projectors equipped with different kinds of optical systems.

The invention has been described above with reference to projection type video display apparatuses that utilize optical modulators in the form of liquid crystal panels as means for generating images. However, the invention can be applied to other types of projection type video display apparatuses utilizing different image generation means. For example, the invention can be applied to a projector employing DLP (Digital Light Processing, which is a registered trademark of Texas Instruments (TI), Inc.).

1. A projection type video display apparatus for projecting beams of imaging light obtained by modulating the light emitted from a lighting system and illuminating optical elements via an integrator lens, the lighting system comprising:
a multiplicity of light sources for emitting substantially parallel beams of light; and
at least one half-mirror and at least one total-reflection mirror for transmitting and/or reflecting the substantially parallel beams of light emitted from the light sources to illuminate substantially the same entire region of the integrator lens.

2. The projection type video display apparatus according to claim 1, wherein the lighting system includes:
a first light source;
a second light source having an optical axis perpendicular to the optical axis of the first light source;
a half mirror arranged at a position where the optical axes of the first and second light sources cross each other and inclined with respect to the respective optical axes of the first and second light sources at 45 degrees;
a total-reflection mirror arranged at a predetermined position on the optical axis of the first light source and downstream of the first half mirror, and inclined with respect to the optical axis of the first light source at 45 degrees, wherein
the half mirror and total-reflection mirror are arranged such that the beams of light transmitted and/or reflected therefrom to the integrator lens are substantially parallel to each other, propagate in close proximity to each other, and fall on the integrator lens at substantially right angles.

3. The projection type video display apparatus according to claim 1, wherein the lighting system includes:
a first light source;
a second light source having an optical axis parallel to the optical axis of the first light source;
a first total-reflection mirror for reflecting the incident beams of light emitted from the second light source in the direction perpendicular to the incident beam;
a half mirror arranged at a position where the beams of light reflected from the total-reflection mirror cross the optical axis of the first light source, and inclined with respect to the optical axis of the first light source and to the beams of light reflected from the total-reflection mirror at 45 degrees; and
a second total-reflection mirror arranged at a predetermined position on the optical axis of the first light source and downstream of the half mirror, and inclined with respect to the optical axis of the first light source at 45 degrees, wherein
the half mirror and second total-reflection mirror are respectively arranged such that the beams of light transmitted and/or reflected therefrom to the integrator lens are substantially parallel to each other, propagate in close proximity, and fall on the integrator lens at substantially right angles.

4. The projection type video display apparatus according to claim 3, wherein
the optical elements of the projector are arranged such that the optical axes of the respective light sources are perpendicular to the direction of the beams of imaging light projected.

5. A projection type video display apparatus for projecting beams of imaging light obtained by modulating the light emitted from a lighting system and illuminating optical elements via an integrator lens, the lighting system comprising:
vertically offset upper and lower pairs of light sources for emitting substantially parallel beams of light; and
half mirrors and total-reflection mirrors for transmitting and/or reflecting the substantially parallel beams of light emitted from the light sources such that the light sources belonging to the upper pair illuminate substantially the same upper half region of the integrator lens while the light sources belonging to the lower pair illuminate substantially the same lower half region of the integrator lens.

6. The projection type video display apparatus according to claim 5, wherein the lighting system includes:
a first light source;
a second light source having an optical axis perpendicular to the optical axis of the first light source;
a first half mirror arranged at a position where the optical axis of the first and second light sources cross each other, and inclined with respect to the respective optical axes of the first and second light sources at 45 degrees;
a first total-reflection mirror arranged at a predetermined position on the optical axis of the first light source and downstream of the first half mirror, and inclined with respect to the optical axis of the first light source at 45 degrees;
a third light source vertically offset with respect to the first light source;
a fourth light source having an optical axis perpendicular to the optical axis of the third light source;
a second half mirror arrange at a position where the optical axes of the third and fourth light sources cross each other, and inclined with respect to the optical axes of the third and fourth light sources at 45 degrees; and
a second total-reflection mirror arranged at a predetermined position on the optical axis of the third light source and downstream of the second half mirror, and inclined with respect to the optical axis of the third light source at 45 degrees, wherein
the half mirrors and total-reflection mirrors are arranged such that the beams of light transmitted and/or reflected therefrom to the integrator lens are substantially parallel to each other, propagate in close proximity to each other, and fall on the integrator lens at substantially right angles.

7. The projection type video display apparatus according to claim 5, wherein the lighting system includes:
a first light source;
a second light source having an optical axis parallel to the optical axis of the first light source;
a first total-reflection mirror for reflecting the incident beams of light emitted from the second light source in the direction perpendicular to the incident beam;
a first half mirror arranged at a position where the beams of light reflected from the first total-reflection mirror crosses the optical axis of the first light source, and inclined with respect to the optical axis of the first light source and to the beams reflected from the first total-reflection mirror at 45 degrees;
a second total-reflection mirror arranged at a predetermined position on the optical axis of the first light source and downstream of the first half mirror, and inclined with respect to the optical axis of the first light source at 45 degrees;
a third light source vertically offset with respect to the first light source;
a fourth light source having an optical axis parallel to the optical axis of the third light source;
a third total-reflection mirror for reflecting the incident beams of light emitted from the fourth light source in the direction perpendicular to the incident beams;
a second half mirror arrange at a position where the beams of light reflected from the third total-reflection mirror crosses the optical axis of the third light source, and inclined with respect to the optical axis of the third light source and to the beams reflected from the third total-reflection mirror at 45 degrees; and
a fourth total-reflection mirror arranged at a predetermined position on the optical axis of the third light source and downstream of the second half mirror, and inclined with respect to the optical axis of the third light source at 45 degrees; wherein
the first and second half mirrors and the second and fourth total-reflection mirrors are arranged such that the beams of light transmitted and/or reflected therefrom to the integrator lens are substantially parallel to each other, propagate in close proximity to each other, and fall on the integrator lens at substantially right angles.

8. The projection type video display apparatus according to claim 7, wherein the optical elements of the projector are arranged such that the optical axes of the respective light sources are perpendicular to the direction of the beams of imaging light projected.
